(19) United States
(12) Patent Application Publication
(10) Pub. No.: US 2005/0201831 A1
(43) Pub. Date: Sep. 15, 2005

(54) Landfill structure using concept of multi-layered reactors and method for operating the same

(75) Inventors: Geom Yong Lee, Seoul (KR); Young Lae Cho, Gyunggi-do (KR); Chang Ryung Yang, Gyunggi-do (KR); Dong Hoon Lee, Seoul (KR); Young Mi Won, Seoul (KR); Young Joon Lee, Seoul (KR); Yeon Jae Park, Gyunggi-do (KR)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: ENV21 Co., Ltd., Seoul (KR)

(21) Appl. No.: 10/416,607

(22) PCT Filed: Nov. 13, 2001
(86) PCT No.: PCT/KR01/01934

§ 371 Date: Oct. 10, 2003

(30) Foreign Application Priority Data
Nov. 13, 2000 (KR) 2000/67140

(51) Int. Cl. B09B 5/00

(52) U.S. Cl. 405/129.95

(57) ABSTRACT

The invention relates to a landfill structure and a method for operating the same and, more particularly, to a landfill structure using a concept of multi-layered reactors, a method for making efficient use of landfill gas generated from the landfill, a method for early stabilizing the landfill and a method for reducing environmental contaminants generated from the landfill.

### TECHNICAL FIELD

The present invention relates to a landfill structure and a method for operating the same and, more particularly, to a landfill structure using a concept of multi-layered reactors, a method for making efficient use of landfill gas generated from the landfill, a method for early stabilizing the landfill and a method for reducing environmental contaminants generated from the landfill.

### BACKGROUND ART

As known well, the quantity of waste daily generated has been increased according to the industrial development, the improved standard of living, etc. There have been developed various methods for processing the waste environmentally, such as incinerating, composting and so on. However, the most waste is disposed in the landfill ultimately, which is expected that the use of the landfill will continue in the future.

Referring to FIG. 1, showing an outline of an example of a conventional landfill, a base 11 is established on a lower part of a landfill 100. The base 11 includes a around waterproof layer 13 for preventing inflow of underground water and outflow of leachate from and to the landfill, a drain layer 12, provided on the base 11, for collecting leachate generated, and leachate drainpipes 17 for draining out the leachate collected in the drain layer 12.

Then, a plurality of waste layers 20 are piled up in the landfill. Middle covered layers 30 are provided on the waste layers 20 for preventing scatter of waste, inflow of rainwater and generation of offensive odors. Horizontal gas collecting pipes 19 are established at a upper side of the respective waste layers 20 for collecting and recycling landfill gas generated from the waste layers 20. An end covered layer 15 is provided on a uppermost waste layer 20, and includes a plant living layer, a waterproof layer and a gas blocking layer in turn, thus preventing inflow of rainwater and outflow of landfill pas to the air. Here, the end covered layer 15 includes the pas blocking layer in general, whereas, the pas blocking layer 18 and the horizontal gas collecting pipe 19 laid in the pas blocking layer 18 are separately depicted as shown in FIG. 1, for the sake of convenience of explanation.

The landfill 100 forms a tight covered space surrounded with the ground waterproof layer 13 and the end covered layer 15. Accordingly, if the landfill leachate and gas generated therefrom are not discharged artificially, the accumulated leachate and gas prevent the degradation of waste and the early stabilization of the landfill. Thus, the conventional landfill 100 discharges the landfill leachate and gas directly through the leachate drainpipe 17 positioned at the lower part and the horizontal gas collecting pipe 19 located at the upper part.

However, in the conventional landfill structure, the middle covered layer 30 prevents the landfill leachate and pas from moving to the respective waste layers 20 since it is made of soils or artificial materials that do not pass the landfill leachate and gas easily and hardened in a predetermined thickness when established, which makes it very difficult to develop the degradation of the waste and the stabilization of the landfill, consequently. That is, the conventional landfill 100 forming a large scale tight covered space surrounded with the ground waterproof layer 13 and the end covered layer 15 includes a plurality of small scale tight covered spaces divided by the respective middle cover layers 30 therein.

Meanwhile, through there may be established slops by daily covered layers 25 provided daily on the respective waste layers 20, since the daily covered layers 25 are formed thin and not hardened, the landfill leachate and gas can be free to move. Accordingly, in view of the landfill leachate and gas, it is learned that the landfill 100 has such a structure that a plurality of small scale tight covered spaces are piled up. However, the conventional landfill 100 has several drawbacks since the landfill 100 is not treated as an assembly of the plural small scale spaces, but as a single large scale space.

For example, the conventional landfill 100 is stabilized by decomposing the waste physically, chemically and biologically only as time passes. Here, the decomposition rate of waste varies based on various reaction requisites, such as air, heat, moisture, pH regulating materials nutrients, etc. However, in the conventional landfill 100 composed of the plural tight covered spaces, these reaction requisites are not provided uniformly and continuously. Accordingly, the decomposition rate is lowered and it takes long time to complete the stabilization of the landfill 100.

Besides, as shown in FIG. 2, an outline showing a conventional landfill disclosed in the U.S. Pat. No. 5,605,417 by Englert et al., the conventional structure for stabilizing the landfill establishes a plurality of horizontal injection pipes 73 and vertical injection wells 75 for supplying moisture and reaction regulating materials. However, when providing the reaction regulating materials to the upper part of the landfill through the horizontal injection pipes 73, the flow of the reaction regulating materials are intercepted by the middle cover layers 30, not to reach the lower part of the landfill 100. In addition, when supplying the reaction regulating materials through the vertical injection wells 75 formed to penetrate into the plural waste layers 20, the reaction regulating materials are not spread in the horizontal direction uniformly since the composition of the waste is not fixed but diversified, which makes it very difficult to control the degradation steps of the landfill 100 properly.

Furthermore, since each the waste layers 20 of the landfill 100 is formed one by one for a long time, the waste layers 20 are decomposed in various degradation stops. For example, as shown in FIG. 3, the wastes in a specific waste layer 20 are reacted in several degradation steps as time elapses.

In a first step, an aerobic degradation status prevails in the waste by the air mixed naturally in the waste. That is, according as aerobic microbes consume O₂, the amount of N₂ and O₂ is sharply decreased.

In a second step, the aerobic degradation status turns into an anaerobic one where acid-forming bacteria are active to ferment complicated organic materials by hydrolysis to generate fatty acid, alcohol. CO₂, H₂, NH₃ and so on. In this step, CO₂ is actively generated to a maximum degree, whereas CH₄ is not produced yet.

In a third step, O₂ is completely exhausted and CH₄-forming bacteria play an active role to generate CH₄ to a maximum degree. Here. H₂ is exhausted by CH₄-forming bacteria in the beginning stage of this step. In general, the third step develops after at least six months from when filling up the waste.

In a fourth step, the decomposition process reaches a normal status where H₄ and CO₂ are generated uniformly. The fourth step is made after one to two years from when filling up the waste.

In a fifth step, the air is mixed in the waste gradually, according as the internal pressure of waste is lowered and the pressure of the atmosphere is increased. Consequently, the generation of CO₂ and CHF₄ is sharply decreased, whereas, the generation of N₂ and O₂ is relatively increased.

As described above, each of the waste layers 20 is decomposed in different degradation steps from each other. However, according to the conventional method and structure for stabilizing the landfill 100, identical reaction requisites are provided in the whole landfill 100 since it is treated as a single tight covered space, which decreases the degradation rate of the waste and cannot even make efficient use of the landfill gas. That is, to make the most use of the landfill gas, it is necessary to control the amount of landfill gas appropriately to meet the quantity required by landfill gas recycling facilities. However, the landfill 100 applying the conventional method has a drawback that it cannot control the decomposition speed to meet the quantity required by the landfill gas recycling facilities.

Besides, the conventional method for stabilizing the landfill 100 by using aerobiosis has another drawback that the period of stabilization is lengthened according as it doesn't cope with the various reaction steps. For example, the process of aerobic degradation of the landfill 100 is similar to that of composting organic waste and both need appropriate maintenance of moisture, air and heat according to the respective reaction steps. In general, the processes of composting organic waste include a first reaction step that a great deal of oxygen is required by high temperature microbes, keeping the temperature at 55° to 55° C. and a second reaction step that the oxygen is not required so much and the reaction temperature drops.

Accordingly, it is necessary to maintain the water content rate less than 60% so that the aerobic degradation requisites do not become anaerobic in the landfill 100. Besides, it is also required that a sufficient amount of oxygen is supplied in the first step and a less amount of oxygen is provided at lower temperature in the second step. However, the convention landfill 100 has another drawback that it is very difficult to control the maintenance of the reaction regulating materials due to the middle covered layers 30 and the complicated composition of the waste, which takes a lot of time to stabilize the landfill 100.

Moreover, the conventional landfill structure is constructed in general such a manner that the daily cover layer 25 or the middle covered layer 30 is covered on the waste layer 20 of a predetermined thickness, then, another waste layer 20 is newly piled up. Therefore, since there is not established an end covered layer 15 on the uppermost waste layer 20 under reclamation, the amount of gas collected by the horizontal gas collecting pipes 19 is not more than a half of the total amount generated in the waste layer 20. Accordingly, a substantial amount of environmental contaminants, such as greenhouse gas, offensive odor materials, volatile organic compounds (VOCs), etc., generated in the landfill 100 under reclamation, are released directly in the air to deteriorate the peripheral environment.

As described above in detail, according to the conventional method and/or structure for stabilizing the landfill 100, the reaction requisites are provided identically in the whole landfill 100 since it is treated as a single tight covered space not considering the complicated composition of the waste and the intercepting effect of the middle covered layers 30. That is, according to the conventional method and structure for stabilizing the landfill 100 applying a concept of “a single reactor”, it is very difficult to supply the reaction regulating materials uniformly into the whole landfill 100 due to the complicated composition of the waste and the intercepting effect of the middle covered layers 30, which delays the degradation speed of the landfill 100. Besides, since the conventional method and structure cannot control the amount of landfill gas generated therefrom, a great deal of environmental contaminants are direct released in the air.

### DISCLOSURE OF INVENTION

Accordingly, the inventor of the present invention describes a brand-new landfill structure using a concept of multi-layered reactors and method for operating the same by regarding the whole landfill as a multi-layered reactors constructed as a plurality of small scale reactors are plied up. That is, according to the present invention, each of the waste layers is constructed to have a function of a single reactor and the respective reaction steps of the waste layers are processed separately, thus easily controlling aerobic or anaerobic degradation steps of the whole landfill.

Besides, the inventor of the present invention describes a brand-new landfill structure using a concept of multi-layered reactors and method for operating the same which can reduce the environmental contaminants by collecting the landfill gas generated from the landfill under declamation to make efficient use of the pas, or by oxidizing the landfill gas generated from the end covered layer by means of soil microbes.

Accordingly, it is an object of the present invention to provide a landfill structure using a concept of multi-layered reactors which comprises at least an exhaust/supply means for exhausting reaction products and/or supplying reaction regulating materials so as to control the various degradation steps of the respective waste layers independently.

It is a further object to provide a landfill structure using a concept of multi-layered reactors which supplies the reaction regulating materials uniformly to the waste layers and discharges the reaction products generated from the waste layers smoothly so as to provide physical, chemical and biological conditions suitable for the respective reaction steps of the waste layers.

Another object of the present invention is to provide a landfill structure using a concept of multi-layered reactors including a porous layer established at the upper or lower part of the respective waste layers, through which the reaction regulating materials are supplied uniformly to the waste layers and the reaction products generated from the waste layers are discharged smoothly, thus preventing the landfill leachate from over-gathering on specific areas, and facilitating the movement of the landfill leachate and gas.

Additional object of the present invention is to provide a method for making efficient use of landfill gas produced and a method for early stabilizing the landfill by selectively supplying the reaction requisites, much as air, moisture, heat, nutrients, microbes, pH regulating materials, reaction inhibitors, landfill gasses, etc., so as to control aerobic or anaerobic degradation in the respective waste layers.

Yet additional object of the present invention is to provide a method for reducing environmental contaminants, such as greenhouse gas, offensive odors. VOCs, etc., generated from the landfill by maintaining the uppermost covered layer in the landfill under reclamation in the aerobic degradation status, and simultaneously keeping the other lower covered layers in the anaerobic degradation status.

Still another object of the present invention is to provide a method for oxidizing offensive odor materials, such as methane, ammonia, H₂S, mercaptan gas, etc., and volatile organic compounds (VOCs), generated from the end covered layer or from the middle covered layer in the landfill under reclamation by supplying various reaction requisites, such as air, heat, moisture, pH regulating materials, nutrients, etc., into at least a porous layer having a high permeability and a high porosity established on the end covered layer or at lower part of the middle covered layer in the landfill under reclamation, so as to activate the aerobic soil microbes, such as methane-oxidizing bacteria, nitrating bacteria and sulfatizing bacteria.

To accomplish an object of the present invention, there is provided a landfill structure including a around waterproof layer formed at a bottom, an end covered layer at a top, a plurality of waste layers piled up from the ground waterproof layer and a plurality of middle covered layers established between the two waste layers, comprising a lower porous layer established at an overall lower part of the waste layer; at least a lower porous pipe laid in the lower porous layer; and an exhaust/supply means for exhausting reaction products and/or supplying reaction regulating materials connected to the lower porous pipes.

To accomplish another object of the invention, there is provided a landfill structure including a ground waterproof layer formed at a bottom, an end covered layer at a top, a plurality of waste layers piled up from the ground waterproof layer and a plurality of middle covered layers established between the two waste layers, further comprising a upper porous layer established at an overall upper part of the waste layer; at least a upper porous pipe laid in the upper porous layer; and an exhaust/supply means for exhausting reaction products and/or supplying reaction regulating materials connected to the upper porous pipes.

The upper and lower porous layers are formed with materials having a high permeability and a high porosity, such as rice husk, sawdust, wood chip, rubber piece, sand, gravel, etc., so as to distribute the reaction regulating materials uniformly and exhaust the reaction products smoothly.

Besides, the upper and lower porous layers are formed further with materials having a high specific surface(SS), a high field capacity (FC) and also a high cation exchange capacity (CEC), such as compost, mud, diatomite, and processed rice husks including pulverized rice husk, carbonized rice husk, expanded rice husk, etc., so as to improve the quality of leachate by purifying leachate passing through the porous layers physically, chemically and biologically.

Furthermore, the upper and lower porous layers have a porosity more than 30%, a permeability more than 1.0×10⁻³ cm/sec, and a specific surface more than 30 m²/g, through which the air supplied from the porous pipe 53 is circulated to activate the aerobic soil microbes, thus oxidizing environmental contaminants using the microbes, such as greenhouse gas, offensive odors, volatile organic compounds (VOCs), etc.

Moreover, the porous pipes are made of plastic has a plurality of apertures established on the outer circumference so as to the reaction regulating materials are freely circulated through the same.

In addition, the exhaust/supply means connected to an end of the porous pipe includes a pump for transferring liquid materials, a blower for circulating gaseous materials and a control valve for controlling the flow of the materials. Besides, the exhaust/supply means further includes a measuring means for measuring temperatures of reaction gases and densities of methane, carbon dioxide and oxygen, extracted from the porous layer, and a control means for controlling amounts of the reaction regulating materials, such as air, moisture, heat, nutrients, microbes, pH regulating materials, reaction inhibitors, landfill gases, etc., injected into the porous layer according to values measured by the measuring means.

Additionally, the daily covered layer established on a slop of the waste layer is composed of materials having a high permeability and a high porosity, such as rice husk, sawdust, wood chip, compost, etc., and air is circulated through the lower porous pipes to activate the aerobic soil microbes, thus oxidizing environmental contaminants using the microbes, such as greenhouse gas, offensive odors, volatile organic compounds (VOCs), etc.

Meanwhile, according to the present invention, if exhausting the reaction products, such as leachate, landfill gas, etc., selectively through the upper or lower porous pipes, and if supplying the reaction regulating materials, such as air, moisture, heat, nutrients, microbes, pH regulating materials, reaction inhibitors, landfill gases, etc., through the upper or lower porous pipes, it is possible to control aerobic or anaerobic degradation steps of the whole waste layers easily.

Besides, according to the present invention, if supplying air into the upper or lower porous pipes to keep a uppermost waste layer under reclamation in the aerobic degradation status, simultaneously, if exhausting leachate through the lower porous pipes to keep the other waste layers than the uppermost waste layer in the anaerobic degradation status, and if injecting reaction regulating materials, such as air, moisture, heat, nutrients, microbes, pH regulating materials, reaction inhibitors, landfill gases, etc., selectively into the upper porous pipes, if necessary, it is possible to reduce environmental contaminants, such as greenhouse gas, offensive odors, volatile organic compounds (VOCs), etc., to be released in the air from the landfill under reclamation.

Furthermore, according to the invention, if injecting air into the porous layer formed in the end covered layer to keep the porous layer in the aerobic degradation status, it is possible to activate the aerobic microbes to oxidize the landfill gas released from the porous layer to be innoxious.

Moreover, according to the invention, if recycling landfill gas by keeping the respectively waste layers in the anaerobic gradation condition for a predetermined period, and if supplying air into the lower porous pipes of the respective waste layers to covert the whole landfill into an aerobic degradation condition, when the landfill gas collected has no economical efficiency it is possible to early stabilizing the landfill.

In addition, according to the invention. If injecting landfill gas through the upper porous pipes, it is possible to make a use of the landfill as a storing place of the landfill gas.

It is to be understood that both the foregoing general description and the following detailed description are exemplary and explanatory and are intended to provide further explanation of the invention as claimed.

### BRIEF DESCRIPTION OF DRAWINGS

FIG. 1 is an outline showing a conventional landfill structure;

FIG. 2 is an outline illustrating a conventional landfill using a concept of a single reactor:

FIG. 3 is a graph showing degradation steps of waste in a general landfill;

FIGS. 4a to 4c depict various landfill structures using a concept of multi-layered reactors in accordance with the present invention;

FIG. 5 shows another landfill structure using a concept of multi-layered reactors in accordance with the invention;

FIGS. 6a to 6d illustrating processes of establishing the landfill structure using a concept of multi-layered reactors in accordance with the invention:

FIG. 7 is an outline illustrating a method for early stabilization of the landfill using a concept of multi-layered reactors in accordance with the invention; and

FIG. 8 is an outline illustrating a method for collecting landfill gases from the landfill using a concept of multi-layered reactors in accordance with the invention.

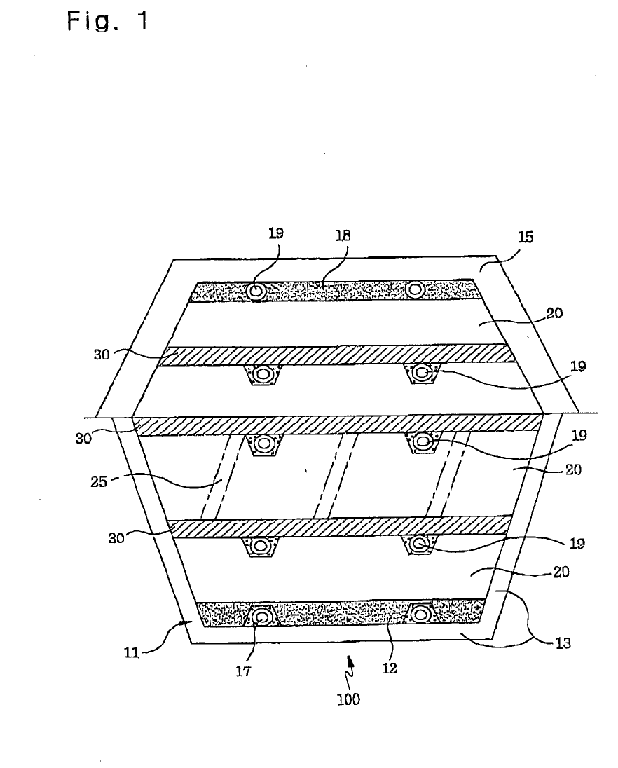

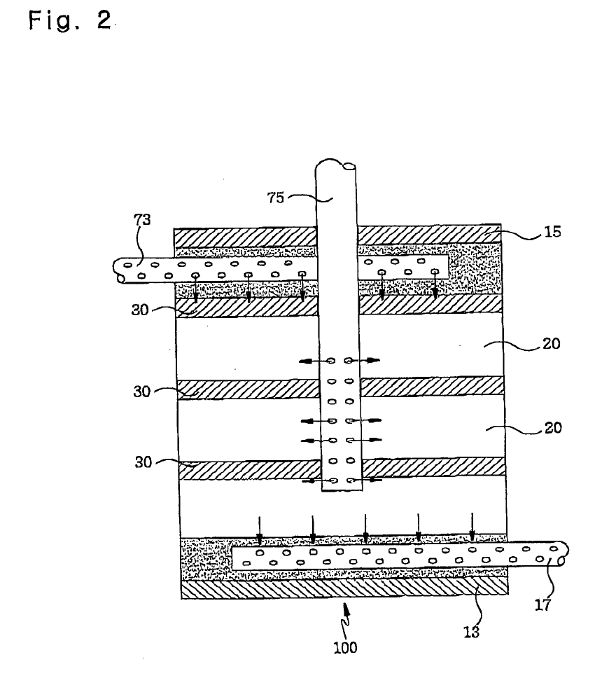

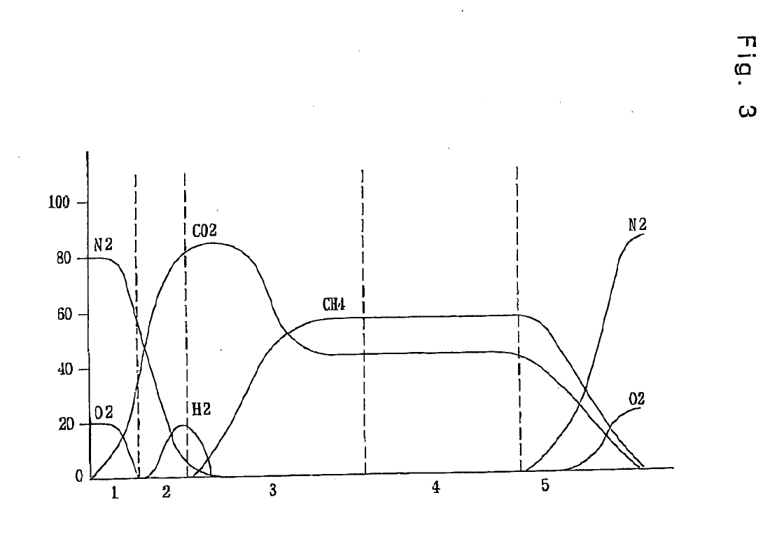

### BEST MODE FOR CARRYING OUT THE INVENTION

Reference will now be made in detail to the preferred embodiments of the present invention, examples of which are illustrated in the accompanying drawings.

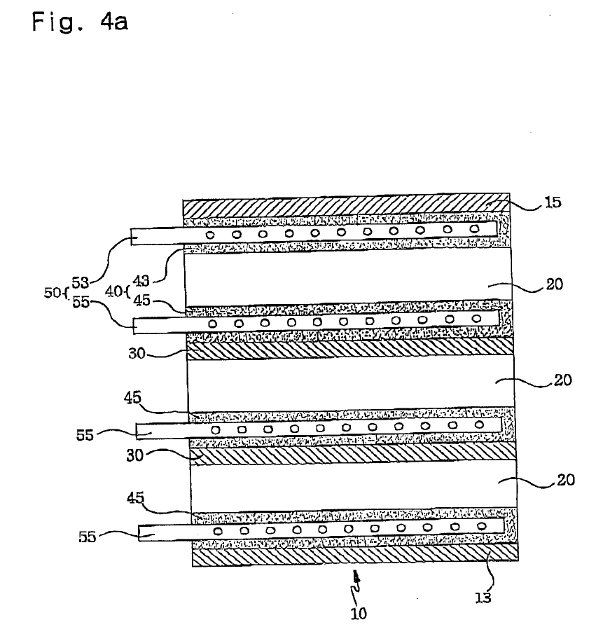

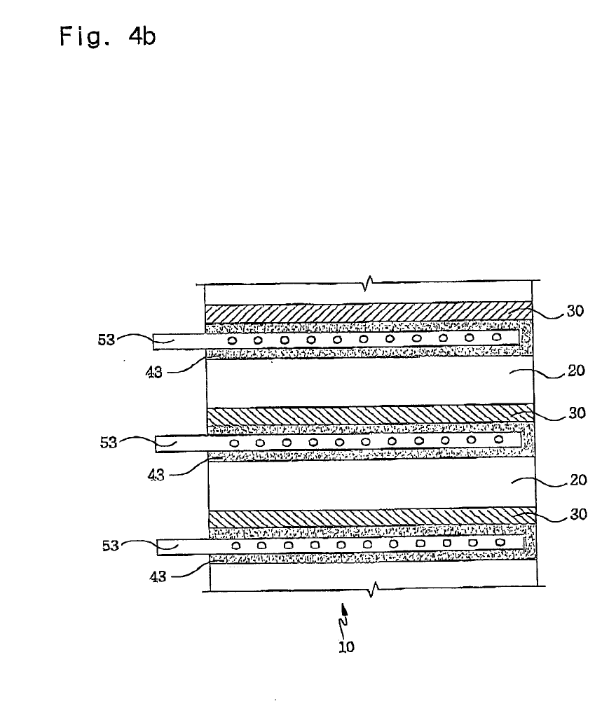

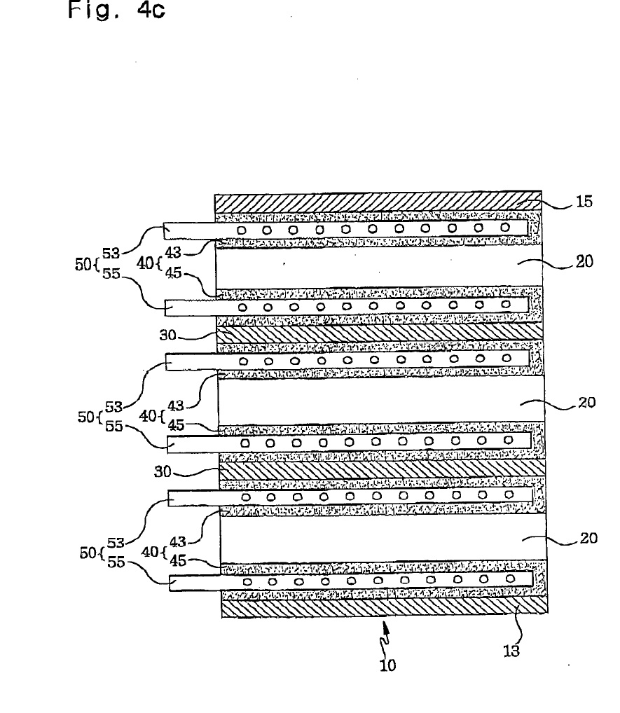

Now referring to FIG. 4a, a landfill 10 using a concept of multi-layered reactors in accordance with the present invention includes a ground waterproof layer 13, an end covered layer 15 and a plurality of waste layers 20 piled up between the two layers 13 and 15. Besides, a plurality of porous pipes 55 are established at the lower part of the respective waste layers 20 to supply reaction regulating materials, such as air, moisture, heat, nutrients, microbes, pH regulating materials, reaction inhibitors, landfill gasses, etc., or to discharge reaction products, such as leachate, landfill gas, etc., and a plurality of porous layers 45 having a predetermined thickness are provided on the porous pipes 55 to distribute the reaction regulating materials to the whole waste layers uniformly or to discharge the reaction products smoothly. That is, the present invention which treats each of the respective waste layers 20 as a single reactor can control the various degradation conditions of the waste layers, respectively, thus managing the whole landfill 10 with a same degradation condition or with different conditions with each other.

Referring to FIG. 4b, the landfill 10 using a concept of multi-layered reactors in accordance with the invention includes a plurality of porous pipes 53 established at the upper part of the respective waste layers 20 to supply the reaction regulating materials or to discharge the reaction products, and a plurality of porous layers 43 having a predetermined thickness provided on the porous pipes 53 to distribute the reaction regulating materials to the whole waste layers uniformly or to discharge the reaction products smoothly. Accordingly, it is possible to control the various degradation conditions of the waste layers, respectively so as to manage the whole landfill 10 with a same degradation condition or with different conditions with each other.

That is, since the landfill 10 of the invention includes the porous layers 40 and the porous pipes 50 for collecting the reaction products, such as landfill leachate and gas, established at the upper or lower part of the respective waste layers 20, it is possible to control the various degradation conditions of the waste layers, respectively. Accordingly, if the degradation conditions of the respective waste layers 20 can be controlled only with the leachate collected, there may be established only the lower porous layers 45 and the porous pipes 55. Whereas, if the degradation conditions of the respective waste layers 20 can be handled only with the landfill gas gathered, or if the amount of gas discharged from the middle covered layer 30 in the landfill under reclamation is too much, there may be provided only the upper porous layers 43 and the upper porous pipes 53. For example, in the landfill 10 where the leachate is less generated, the lower porous layer 45 and the porous pipe 55 can be omitted, and the upper porous layers 43 and the porous pipes 53 are established to collect the landfill gas, through which the various degradation conditions of the waste layers can be controlled, respectively. Accordingly, it is possible to manage the whole landfill 10 with a same degradation condition or with different conditions with each other.

Meanwhile, if the progress of the reclamation in the landfill is delayed, the amount of landfill gas emitted from the middle covered layer is increased until the end covered layer is formed. Here, it is desired to control the degradation condition of the uppermost waste layer by collecting the landfill gas through the upper porous layers 43 and the porous pipes 53, established at the upper part of the respective waste layers 20. For example, the porous layer 43 has a porosity more than 30% and a permeability more than 1.0×10⁻³ cm/sec, through which the air supplied from the porous pipe 53 is circulated to activate the aerobic soil microbes. Accordingly, the soil microbes make the landfill gas innoxious to be released in the air.

That is, the conventional middle covered layers has no function of providing various reaction requisites, such as air, heat, moisture, pH regulating materials, nutrients, etc, to activate the aerobic soil microbes, such as methane-oxidizing bacteria, nitrating bacteria and sulfatizing bacteria, which oxidize offensive odor materials, such as methane, ammonia, H₂S, mercaptan gas, etc., and volatile organic compounds (VOC). Accordingly, the present invention is made to increase the oxidizing rate of the landfill gas by establishing artificial equipments in the end covered layer and the middle covered layer in the landfill under reclamation so as to activate the aerobic soil microbes therein.

Meanwhile, to control the respective waste layers 20 more precisely, it is desired to establish upper and lower porous layers 40 and pipes 50 at the upper and lower parts of the waste layers 20, respectively, so as to supply the reaction regulating materials, such as air, moisture, heat, nutrients, microbes, pH regulating materials, reaction inhibitors, landfill gasses, etc. As shown in FIG. 4c, a plurality of porous pipes 50 (53 and 55) for supplying the reaction regulating materials to the waste layers or for discharging the reaction products are provided at the upper and lower parts of the respective waste layers 20, and a plurality of porous layers 40 (43 and 45) having predetermined thickness for distributing the reaction regulating materials uniformly or discharging the reaction products smoothly are established on the porous pipes 40. Accordingly, it is possible to control the various degradation conditions of the waste layers, respectively so as to manage the whole landfill 10 with a same degradation condition or with different conditions with each other.

Consequently, the landfill structure using a concept of multi-layered reactors has such a structure that a plurality of small size reactors surrounded with upper and lower middle covered layers 30 are piled up. Here, the reactor means a tight covered receptacle used for physical, chemical and biological reactions. That is, each of the waste layers 20 of the landfill 10 in accordance with the invention can form a single reactor, having a tight covered space by the upper and lower middle covered layers 30, which supplies the reaction regulating materials or discharges the reaction products through the porous layers 40 and pipes 50.

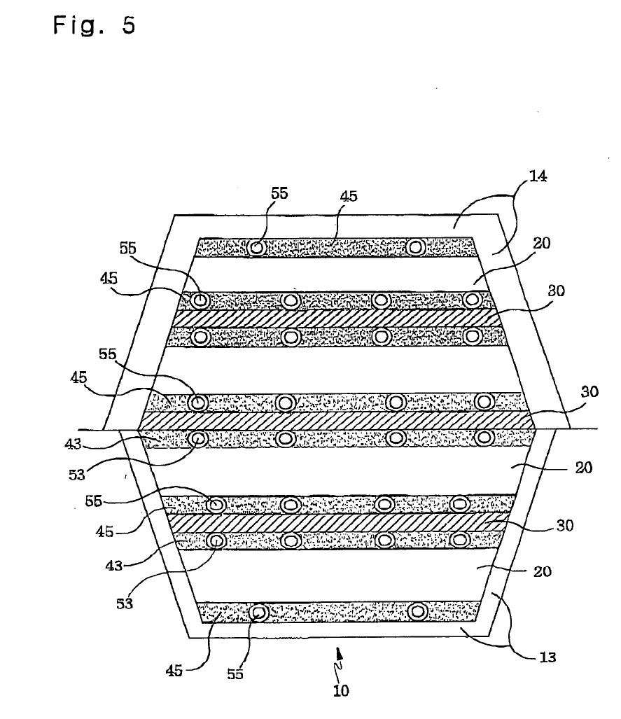

Now referring to FIG. 5, showing a concrete landfill structure using a concept of multi-layered reactors in accordance with the invention, the landfill 10 forms a large scale tight covered space surrounded with a ground waterproof layer 13 at the bottom and an end covered layer 15 at the top, wherein a plurality of waste layers 20 surrounded with the upper and lower middle covered layers 30 are, piled up, a plurality of lower porous layers 45 are established at the lower part of the respective waste layers 20, and a plurality of lower porous pipes 55 are provided in the lower porous layers 45. Besides, a plurality of porous layers 43 is installed at the upper part of the respective waste layers 20, separately from the lower porous layers 45 and pipes 55, and a plurality of upper porous pipes 53 are established in the upper porous layers 43.

As described above, the landfill 10 using a concept of multi-layered reactors in accordance with the invention includes at least a porous layer 50 and pipe 40 in the waste layer 20 so that each of the waste layers 20 can function as a single reactor. Accordingly, it is possible to control the degradation conditions of the respective waste layers 20 independently.

The porous layers 40 (43 and 45) of the invention are made of materials having high permeability and porosity, such as rice husk, sawdust, wood chip, rubber piece, sand, gravel, etc., through which the reaction regulating materials injected through the porous pipes 50 (53 and 55) can be distributed uniformly or the reaction products generated from the waste layer 20 can be discharged smoothly. For this sakes, the porous layer 40 is spread on the entire surface of the waste layer 20 or on a predetermined area to the extent that the reaction regulating materials can be distributed uniformly or the reaction products can be discharged smoothly. Besides, the porous layer 40 is established in a thickness to the extent that the reaction regulating materials injected can be moved sufficiently in the horizontal direction, or in a height to the extent that the porous pipes 50 can be laid completely. Accordingly, it is desired to establish the porous layer 40 in the thickness of 10 cm to 50 cm, preferably 20 cm.

The porous pipe 50 may be made of various materials and forms considering the size and the characteristic of the landfill 10, whereas it is desired to use a plastic pipe less than 10 cm in diameter in view of the convenience of work. Besides, the porous pipe 50 has a plurality of apertures, through which the reaction regulating materials and the reaction products can circulated. Moreover, the porous pipes 50 may be installed in various forms according to size and characteristic of the landfill 10, whereas it is desired to establish the pipes 50 on the entire surface of the porous layer 40 at regular intervals in general, or along the edges of the porous layer 40 partially.

Meanwhile, the reaction regulating materials injected through the porous layer 40 and the porous pipe 50 include leachate, landfill gas, rainwater, groundwater, nutrients, pH regulating materials, reaction inhibitors, microbes, air, heat, etc., and the reaction products are landfill gas, leachate, etc. Especially, the leachate, rainwater and groundwater are essential to keep the moisture, to control the temperature of the waste layer 20, and to act as a medium for supplying the other reaction regulating materials. The heat is necessary to maintain the reaction temperature of the waste layer 20 properly. The reaction inhibitor for inhibiting the growth of microbes, such as chopper (Cu) and chopper oxide (CuO), is used to regulate the amount of methane gas generated. The landfill gas is applied to exhaust the oxygen existing in the waste layer 20 compulsively so as to turn into the anaerobic degradation status. As for the other reaction regulating, materials, detailed description will be omitted as they can be applied by those skilled in the art.

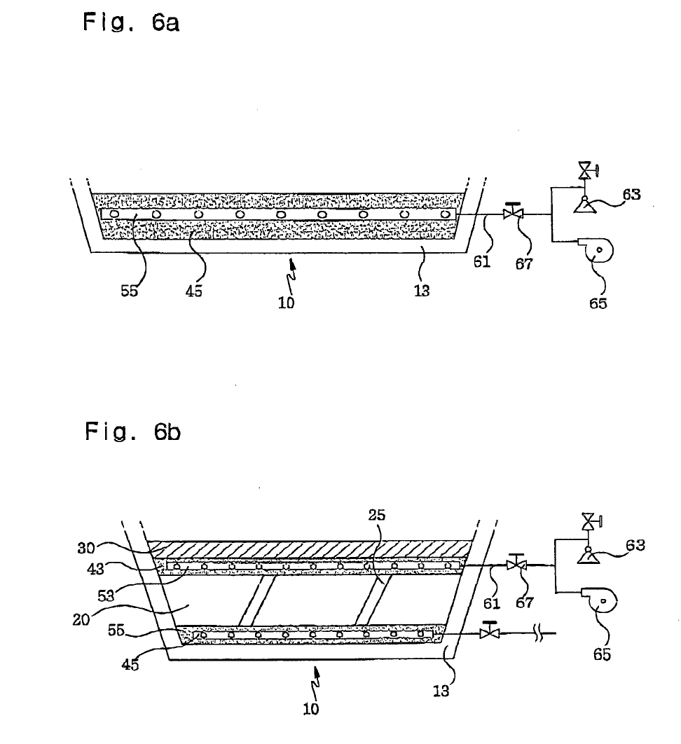

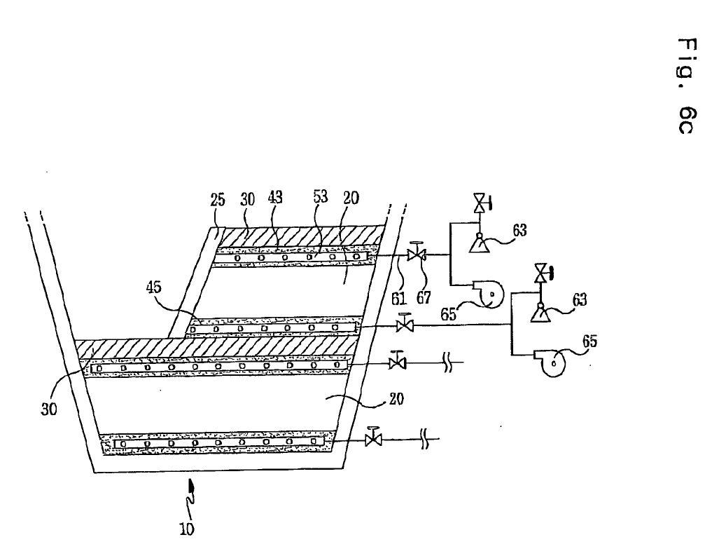

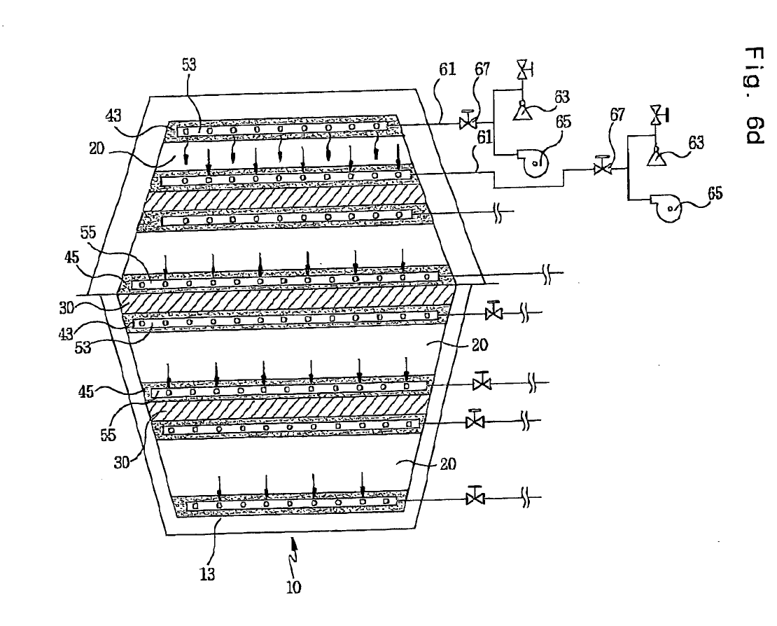

Referring to FIGS. 6a to 6c, each of the porous pipes 50 is connected to a header 61 having an exhaust/supply means for exhausting the reaction products and supplying the reaction regulating materials. Here, the exhaust/supply means includes a pump 63 for transferring liquid materials, a blower 65 for circulating gaseous materials and a control valve 67 for controlling the flow of the materials. Besides, the exhaust/supply means may establish the porous pipe 50 and the header 61 slantly so as to exhaust the leachate easily by gravity.

The other plumbing of the porous pipes 50 and the headers 61 and installation of the exhaust/supply means can be made in various forms according to size and structure of the landfill 10, however, detailed description will be omitted as they can be applied by those skilled in the art.

The porous layer 40 of the invention may further includes materials having a high specific surface(SS), a high field capacity (FC) and also a high cation exchange capacity (CEC), such as compost, mud, diatomite, and processed rice husks including pulverized rice husk, carbonized rice husk, expanded rice husk, etc. That is, when the materials having high SS, FO and CEC are added to the porous layer 40, circulating waters, such as leachate and groundwater, are processed physically, chemically and biologically to be improved while passing the porous layer 40. Besides, when the compost, mud, diatomite and processed husks are mixed to the porous layer 40, the SS and FC are increased to provide a favorable environment to cultivation of various microbes, and CEO is raised to remove heavy metal ions, thus lowering contamination level of leachate and heavy metal, respectively.

Furthermore, the porous layer 40 of the invention formed with rice husk, sawdust, wood chi) and rubber piece, which have low terminal conductivity, activates the cultivation of microbes, since those materials relax the difference of temperature changes.

As described above in detail, according to the present invention, it is possible to control the degradation conditions of the waste layers 20 by selectively exhausting the reaction products smoothly or supplying the reaction regulating materials uniformly through the porous layers 40 and the porous pipes 50 laid therein. Consequently, according to the present invention, it is possible to early stabilize the landfill 10, to enhance the efficiency of recycling the landfills gas, and to reduce the contaminants, by controlling the degradation conditions of the respective waste layers 20 properly.

Hereinafter, the landfill structure using a concept of multi-layered reactors and the method for operating the same in accordance with the present invention will be described in detail.

First referring to FIG. 6a, there is depicted a landfill structure in accordance with the invention. The landfill 10 comprises a ground waterproof layer 13 established at the bottom for proofing for preventing the outflow of leachate and the inflow of groundwater, a lower porous pipe 55 for collecting leachate and a lower porous layer 45 for exhausting the leachate collected by the pipe 55.

Here, the porous layer 45 established 30 cm to 50 cm in thickness with materials having high permeability and porosity, such as sand, gravel, etc. facilitates the exhaust of leachate. An end of the porous pipe 55 is connected to a header 61. An end of the header is connected to a pump 63 for transferring leachate, a blower 65 for circulating gaseous materials and a control valve 67 for controlling the flow of the materials, respectively. Meanwhile, the structures of the lower porous pipe 55 and the lower porous layer 45 are analogous with those of the conventional leachate drainpipe 17 and the drain layer 12.

As shown in FIG. 6b, a new waste layer 20 is formed at the upper part of the lower porous layer 45 by newly carried wastes. Then, a daily covered layer 25 and/or a middle covered layer 30 may be laid at the upper part of the waste layer 20. That is, it is usual for a large scale landfill to provide the daily covered layer 25 and the middle covered layer 30, however, in case of a small scale landfill, only the daily covered layer 25 may be established without the middle covered layer 30.

According to the present invention, a upper porous layer 43 and a plurality of upper porous pipes 53 are provided prior to forming the covered layers 25 and 30. An end of the upper porous pipe 53 is connected to another header 61. An end of the header is connected to another pump 63 for transferring leachate, another blower 65 for circulating gaseous materials and another control valve 67 for controlling the flow of the materials transferred and circulated, respectively. Then, a middle covered layer 30 is laid on the upper porous layer 43 the same with the conventional manner, thus completing a waste layer 20.

The waste layer 20 constructed as above can reduce the environmental toxic materials with the aerobic degradation by air supplied through the porous pipes 50. That is, since there is not established the end covered layer 15 for preventing the release of the landfill gases on the uppermost waste layer 20 in the landfill 10 under reclamation, a substantial portion of environmental contaminants, such as greenhouse gas, offensive odor materials, VOCs, etc., generated therefrom are released in the air. Therefore, the present invention is to provide a landfill structure which injects air to the lower porous pipe 55 of the uppermost waste layer 20 to turn into the aerobic degradation status, in which a proper temperature for cultivation of microbes is maintained and the soil microbes are contacted with the landfill gases, and supplies nutrients, pH regulating materials, etc., essential for the cultivation of soil microbes appropriately, thus reducing the environmental toxic materials to be released in the air.

Next, as shown in FIG. 6c depicting a large scale landfill 100 where daily covered layers 25 are laid day by day, it is possible to reduce the environmental contaminants, such as greenhouse gas, offensive odor materials, VOCs, etc., generated from daily covered layers 25, by controlling the waste layers 20 to turn into the aerobic degradation status. Especially, if the daily covered layers 25 are laid by mixed with materials having superior specific surface (SS), such as rice husk, sawdust, wood chip, rubber piece, sand, gravel, etc., and it aerobic microbes, such as methane-oxidizing bacteria, nitrating bacteria and sulfatizing bacteria are provided to the daily covered layers 25, the environmental contaminants generated can be substantially reduced.

As depicted in FIG. 6d, the lower porous pipes 55 and the lower porous layer 45 are provided at the upper part of the middle covered layer 30, and a new waste layer 20 is formed thereon. Then, the upper porous pipes 53 and the upper porous layer 43 are further established at the upper part of the waste layer 20, and a new middle covered layer 20 is laid thereon. Then, each one end of the upper and lower porous pipes 50 (53 and 55) is connected a header, and each one end of the header is connected to a pump 63 for transferring leachate, a blower 65 for circulating gaseous materials and a control valve 67 for controlling the flow of the materials transferred and circulated, respectively, thus controlling each of the degradation conditions of the waste layers 30, independently.

When forming the uppermost waste layer 20 as described above, it is necessary to supply air to the lower porous pipes 55, and provide moisture properly to the upper porous pipes 45 if required, so as to keep the waste layer 20 in the aerobic degradation status. Whereas, the lower waste layer 20 under the aerobic degradation status is converted into the anaerobic degradation status by suspending air supply and providing landfill gas.

Meanwhile, if the amount of the landfill gas released from the uppermost middle covered layer 30 is increased, it is necessary to extract the landfill gas through the upper porous layer 43 and the upper porous pipes 53 so as to reduce the environmental contaminants, such as greenhouse gas, offensive odors, VOCs, etc. Besides. If the density of methane gas among the landfill gases extracted is high, it can be sent to the landfill gas recycling facilities.

Where the porous pipes 40 and layers 50 are installed at both the upper and lower parts of the waste layer 20, it is possible to exhaust the landfill leachate through the lower porous pipes 55 and supply the reaction regulating materials, such as air, moisture, heat, nutrients, microbes, pH regulating materials, reaction inhibitors, landfill gases, etc., through the upper porous pipes 45, if required according to the degradation condition of the waste layer 20, thus controlling the waste layer 20 to take place optimum aerobic or anaerobic degradation. Here, the microbes supplied are aerobic or anaerobic bacteria cultivated for the sake of waste degradation.

According to the present invention, while the landfill 10 using a concept of multi-layered reactors repeats the processes described above, several waste layers 20 are piled up and the uppermost waste layer 20 gets into the aerobic degradation. The object of providing the aerobic degradation, controlled better than that raised naturally by air contained in the waste in the conventional landfill, is to accelerate the recycling of landfill gas and the early stabilization of waste landfill. Next, when an end covered layer 15 is laid on the uppermost waste layer 20, the landfill processes are completed. Here, it is desired to keep the uppermost waste layer 20 in the aerobic degradation status so as to reduce the environmental contaminants generated in the landfill 10. Here, since the structures of the upper porous layer 43 and the upper porous pipes 53 established in the uppermost waste layer 20 have analogous with those of the conventional gas blocking layer 18 and the horizontal gas collecting pipe 19, they can be commonly used.

Meanwhile, in view of the early stabilization of the landfill 10, it is desirable to keep the whole landfill 10 in the aerobic degradation status, whereas, in view of the recycling of landfill gases produced in the landfill 10, it is desirable to keep the landfill 10 in the anaerobic degradation status so as to generate useful gas, such as methane gas. Especially, since the landfill structure according to the invention can control the degradation conditions of the respective waste layers 20, it is easy to regulate the amount of the landfill gas to meet the demands of the recycling facilities. For example, when the amount of methane gas generated is insufficient, the reaction regulating materials are supplied to accelerate the acid and methane generation in the second to fourth anaerobic degradations. Whereas, when the amount of methane gas generated is excessive, the reaction inhibitors are furnished or the exhaust of the reaction products is intercepted to suspend the degradation reactions temporarily, thus saving the methane gas to be released in the air.

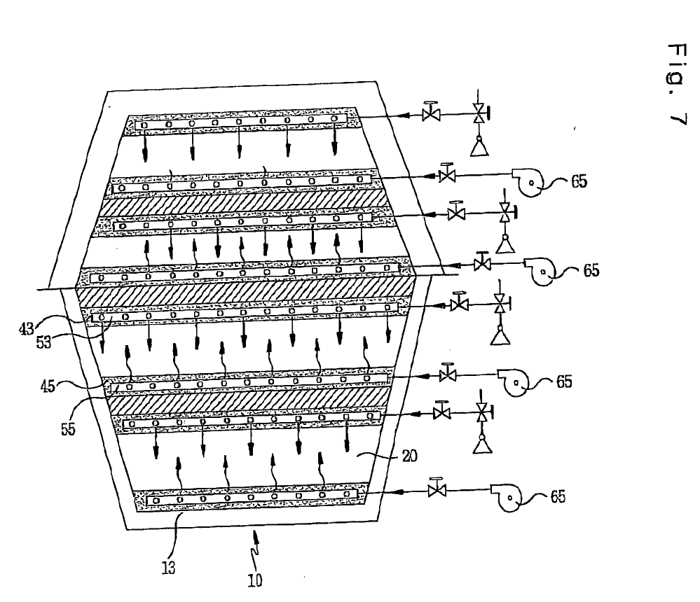

Meanwhile, if the landfill gas generated in the landfill 10 according to the invention has no economical efficiency, it is possible to early stabilize the landfill 10 by keeping the whole landfill 10 in the aerobic degradation status, as shown in FIG. 7. Here, air pressurized through the blower 65 is transferred to the low part of the respective waste layers 20 through the header 61, and moisture is furnished to the upper porous pipe 45 of the waste layers 20, if necessary.

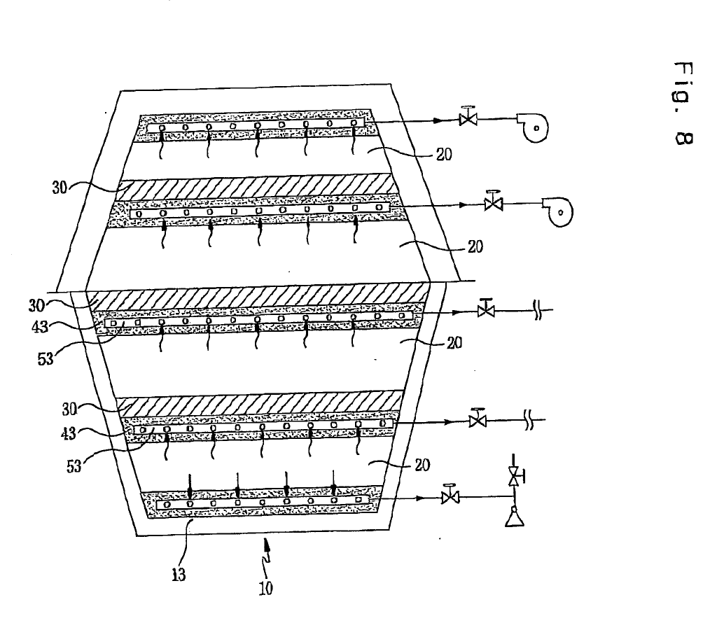

Next, as shown in FIG. 8, if materials having a high specific surface, such as rice husk, sawdust, wood chip, compost, etc., are mixed with the middle covered layer 30, and appropriate microbes is inoculated in the middle layer 30 if necessary, and air is supplied in the waste layer 20, the aerobic microbes flourish in the middle covered layer to reduce the environmental contaminants, such as greenhouse gas, offensive odor materials, VOCS, etc., to be released in the air.

### INDUSTRIAL APPLICABILITY

Accordingly, the landfill structure of the invention can reduce environmental contaminants substantially, such as greenhouse gas, offensive odors, VOCs, etc., generated from the landfill, by keeping the uppermost waste layer under reclamation or the whole landfill completed in the aerobic degradation condition.

Besides according to the invention, it is possible to make most use of the landfill gas generated by keeping the waste layers in the anaerobic degradation status and controlling the reaction regulating materials of the respective waste layers property so as to regulate the amount of landfill gas to meet the demands of the recycling facilities.

Furthermore, according to the invention, if the aerobic degradation condition in the landfill is controlled from the beginning, it is possible to enhance the anaerobic degradation rate to be developed subsequently, to control the anaerobic degradation conditions of the respective waste layers appropriately, and to convert the whole landfill into the aerobic degradation status very easily if there is no economical efficiency on the landfill gas generated, thus early stabilized the landfill.

Moreover, according to the invention, it is possible to improve the quality of leachate to be released, by circulating the leachate through the porous layers established at the upper and/or lower parts of the respective waste layers.

In addition, according to the invention. It is possible to reduce the amount of landfill gas generated from the uppermost waste layer and the dally covered layer in the landfill under reclamation, by extracting the gas through the porous layers established at the upper and/or lower parts of the respective waste layers.

1. A landfill structure including a ground waterproof layer formed at a bottom, an end covered layer at a top, a plurality of waste layers piled up from the ground waterproof layer and a plurality of middle covered layers established between the two waste layers, comprising:
a lower porous layer established at an overall lower part of the waste layer;
at least a lower porous pipe laid in the lower porous layer and
an exhaust/supply means for exhausting reaction products and/or supplying reaction regulating materials connected to the lower porous pipes.

2. The landfill structure as recited in claim 1,
wherein the lower porous layer is composed of materials having a high permeability and a high porosity, such as rice husk, sawdust, wood chip, rubber piece, sand, travel, etc., so as to distribute the reaction regulating materials uniformly and exhaust the reaction products smoothly.

3. The landfill structure as recited in claim 1 or 2,
wherein the lower porous is composed of materials having a high specific surface (SS), a high field capacity (FC) and a high cation exchange capacity (CEC), such as compost, mud, diatomite, and processed rice husks including pulverized rice husk, carbonized rice husk and expanded rice husk, etc., so as to improve quality of leachate by purifying leachate passing through the lower porous layer physically, chemically and biologically.

4. The landfill structure as recited in claim 1 or 2,
wherein the lower porous pipe made of plastic has a plurality of apertures established on an outer circumference so as to the reaction regulating materials are freely circulated through the same.

5. The landfill structure as recited in claim 1 to 4,
wherein the exhaust/supply means connected to an end of the porous pipe includes a pump for transferring liquid materials, a blower for circulating gaseous materials and a control valve for controlling the flow of the materials.

6. The landfill structure as recited in claim 5,
wherein the exhaust/supply means further includes a measuring means for measuring temperatures of reaction gases and densities of methane, carbon dioxide and oxygen, extracted from the porous layer, and a control means for controlling amounts of the reaction regulating materials, such as air, moisture, heat, nutrients, microbes, pH regulating materials, reaction inhibitors, landfill gases, etc., injected into the porous layer according to values measured by the measuring means.

7. A landfill structure including a ground waterproof layer formed at a bottom, an end covered layer at a top, a plurality of waste layers piled up from the ground waterproof layer and a plurality of middle covered layers established between the two waste layers, comprising:
at least a porous layer made of materials having a high permeability between the waste layer and the middle covered layer;
at least a porous pipe laid in the porous layer:
an exhaust/supply means connected to the porous pipes for exhausting reaction regulation materials and/or supplying reaction products.

8. A landfill structure including a ground waterproof layer formed at a bottom, an end covered layer at a top, a plurality of waste layers piled up from the ground waterproof layer and a plurality of middle covered layers established between the two waste layers,
wherein daily covered layers, composed of materials having a high permeability and a high porosity, such as rice husk, sawdust, wood chip, compost, etc., are provided on slops of the middle covered layers,
wherein porous layers, made of materials having a high permeability and a high porosity, are established at lower parts of the waste layers,
wherein at least a porous pipe through which air supplies is established in the porous layer,
thus reducing environmental contaminants, such as greenhouse gas, offensive odors, volatile organic compounds (VOCs), etc., to be released in the air from the middle covered layer.

9. A landfill structure including a ground waterproof layer formed at a bottom, an end covered layer at a toe, a plurality of waste layers piled up from the ground waterproof layer and a plurality of middle covered layers established between the two waste layers, comprising:
a upper porous layer established at an overall upper part of the waste layer;
at least a upper porous pipe laid in the upper porous layer; and
an exhaust/supply means connected to the upper porous pipes for exhausting reaction products and/or supplying reaction regulating materials.

10. The landfill structure as recited in claim 9,
wherein the porous layer is made of materials having a porosity more than 30% and a permeability more than 1.0×10⁻³ cm/sec.

11. The landfill structure as recited in claim 9,
wherein the porous layer is made of materials having a specific surface more than 30² m/g.

12. The landfill structure as recited in claim 9,
wherein the porous layer is mixed with at least each one selected from two kinds of materials, one having a high porosity and a high permeability, such as rice husk, sawdust, wood chip, rubber piece, sand, gravel, etc., and another having a high specific surface, such as compost, mud, diatomite, pulverized rice husk, carbonized rice husk, expanded rice husk, etc.

13. The landfill structure as recited in claim 9,
wherein the exhaust/supply means includes an exhausting means having a plurality of gas collecting pipes established in the porous layer for collecting landfill gases generated and a blower for transferring the landfill gases collected through the gas collecting pipes, a supplying means having a plurality of air injecting pipes provided in the porous layer for injecting air and a blower for transferring the air through the air injecting pipes.

14. The landfill structure as recited in claim 13,
wherein the exhausting means further includes a measuring means for measuring temperatures of reaction gases and densities of methane, carbon dioxide and oxygen, extracted from the porous layer, and
wherein the supplying means further includes a control means for controlling amounts of the reaction regulating materials, such as air, moisture, heat, nutrients, microbes, pH regulating materials, reaction inhibitors, landfill gases, etc., injected into the porous layer according to values measured by the measuring means.

15. A method for operating a landfill composed of a ground waterproof layer formed at a bottom, an end covered layer at a top, a plurality of waste layers plied up from the ground waterproof layer, a plurality of middle covered layers established between the two waste layers, at least a porous layer established at an overall upper part of the waste layer, at least a porous pipe laid in the porous layer, and an exhaust/supply means connected to the upper porous pipes for exhausting reaction products and/or supplying reaction regulating material,
the method comprising the processes of:
supplying air into the porous pipes to keep the porous layer established on a uppermost waste layer under reclamation in an aerobic degradation status, and
injecting reaction regulating materials, such as air, moisture, heat, nutrients, microbes, pH regulating materials, reaction inhibitors, landfill gases, etc. . . selectively to the waste layer,
thus reducing environmental contaminants, such as greenhouse gas, offensive odors, volatile organic compounds (VOCs), etc., to be released in the air from the landfill under reclamation.

16. A method for operating a landfill constructed with a middle covered layer established at a upper part of a waste layer, a upper porous layers provided between the waste layer and the middle covered layer, at least a porous upper porous pipe laid in the upper porous layer and an exhausting means connected to the upper porous pipes for exhausting reaction products,
the method comprising the process of;
recycling or incinerating methane gas extracted through the upper porous pipe.

17. A method for operating a landfill constructed with a middle covered layer established at a upper part of a waste layer, a upper porous, layers provided between the waste layer and the middle covered layer, at least a porous upper porous pipe laid in the upper porous layer and an exhausting means connected to the upper porous pipes for exhausting reaction products,
the method comprising the process of:
injecting landfill gas through the upper porous pipes so as to make a use of the landfill as a storing place of the landfill gas.

18. A landfill structure including a ground waterproof layer formed at a bottom, an end covered layer at a top, a plurality of waste layers piled up from the around waterproof layer and 9 plurality of middle covered layers established between the two waste layers,
the landfill comprising:
a plurality of porous layers established at overall upper and lower parts of the waste layer;
at least a porous pipe laid in the porous layer; and
an exhaust/supply means connected to the porous pipes for exhausting reaction products and/or supplying reaction regulating materials

19. A method for operating a landfill composed of a around waterproof layer formed at a bottom, an end covered layer at a top, a plurality of waste layers piled up from the ground waterproof layer, a plurality 15 of middle covered layers established between the two waste layers, at least a porous layer established at overall upper and lower parts of the waste layer, at least a upper porous pipe and at least a lower porous pipe laid in the porous layer, and an exhaust/supply means connected to the porous pipes for exhausting reaction products and/or supplying reaction regulating materials,
the method comprising the processes of:
exhausting reaction products, such as leachate, landfill gas, etc., selectively through the upper or lower porous pipes, and
supplying reaction regulating materials, such as air, moisture, heat, nutrients, microbes, pH regulating materials, reaction inhibitors, landfill gases, etc., through the upper or lower porous pipes,
thus control aerobic or anaerobic degradation steps of the whole waste layers easily.

20. A method for operating a landfill composed of a ground waterproof layer formed at a bottom, an end covered layer at a top, a plurality of waste layers plied up from the ground waterproof layer, a plurality of middle covered layers established between the two waste layers, at least a porous layer established at overall upper and lower parts of the waste layer, at least a upper porous pipe and at least a lower porous pipe laid in the porous layer, and an exhaust/supply means connected to the porous pipes for exhausting reaction products and/or supplying reaction regulating materials,
the method comprising the processes of:
supplying air into the upper or lower porous pipes to keep a uppermost waste layer under reclamation in an aerobic degradation status,
exhausting leachate through the lower porous pipes to keep the other waste layers than the uppermost waste layer in an anaerobic degradation status, and
injecting reaction regulating materials, such as air, moisture, heat, nutrients, microbes, pH regulating materials, reaction inhibitors, landfill gases, etc., selectively into the upper porous pipes, if necessary,
thus reducing environmental contaminants, such as greenhouse gas, offensive odors, volatile organic compounds (VOCs), etc., to be released in the air from the landfill under reclamation.

21. A method for operating a landfill constructed with a middle covered layer including materials having a high specific surface, such as rice husk, sawdust, wood chip, compost, etc. established at a upper part of a waste layer, at least a porous layer provided at an overall lower part of the waste layer, at least a lower porous pipe laid in the porous layer, and an exhaust/supply means connected to the porous pipes for exhausting reaction products and/or supplying reaction regulating materials,
the method comprising the processes of:
supplying air into the lower porous pipes to keep a uppermost waste layer under reclamation in an aerobic degradation status,
inoculating aerobic microbes, such as methane-oxidizing bacteria, nitrate-generating bacteria and sulfatizing bacteria, etc., into a uppermost middle covered layer;
thus oxidizing environmental contaminants using the microbes, such as greenhouse gas, offensive odors, volatile organic compounds (VOCs), etc., generated from the uppermost middle covered layer and released in the air from the landfill under reclamation.

22. A method for operating a landfill constructed with a middle covered layer established at a upper part of a waste layer, a upper porous is layers provided between the waste layer and the middle covered layer, at least a porous upper porous pipe laid in the upper porous layer and an exhausting means connected to the upper porous pipes for exhausting reaction products,
the method comprising the process of:
recycling or incinerating methane gas extracted through the upper porous pipes.

23. A method for operating a landfill composed of a ground waterproof layer formed at a bottom, an end covered layer at a top, a plurality of waste layers piled up from the ground waterproof layer, a plurality of middle covered layers established between the two waste layers, at least a porous layer established at overall upper and lower parts of the waste layer, at least a upper porous pipe and at least a lower porous pipe laid in the porous layer, and an exhaust/supply means connected to the porous pipes for exhausting reaction products and/or supplying reaction regulating materials,
the method comprising the processes of
recycling landfill gas by keeping the respectively waste layers in an anaerobic gradation condition for a predetermined period,
supplying air into the lower porous pipes of the respective waste layers to covert the whole landfill into an aerobic degradation condition, if the landfill gas collected has no economical efficiency,
thus early stabilizing the landfill.

24. A method for operating a landfill constructed with a plurality of waste layers, an end covered layer established at a uppermost waste layer, a porous layer made of at least a material selected among rice husk, sawdust, wood chip, compost, pulverized rice husk, carbonized rice husk and expanded rice husk, and a supplying means established in the porous layer for supplying air therein,
the method comprising the processes of:
supplying air into the porous layer to keep the porous layer in an aerobic degradation status,
inoculating aerobic microbes, such as methane-oxidizing bacteria, nitrate-generating bacteria and sulfatizing bacteria, etc., into the porous layer,
thus oxidizing environmental contaminants using the microbes, such as greenhouse gas, offensive odors, volatile organic compounds (VOCs), etc., generated from the porous layer and released in the air.
